(19) United States
(12) Patent Application Publication
(10) Pub. No.: US 2009/0182825 A1
(43) Pub. Date: Jul. 16, 2009

(54) METHOD AND SYSTEM FOR PROVIDING SOURCE INFORMATION OF DATA BEING PUBLISHED

(75) Inventor: Benjamin Joseph Fletcher, Huddersfield (GB)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/139,178

(22) Filed: Jun. 13, 2008

(30) Foreign Application Priority Data
Jul. 4, 2007 (EP) 07111706.3

(51) Int. Cl. G06F 15/16

(52) U.S. Cl. 709/206; 709/224

(57) ABSTRACT

A method and system for providing source information of data being published are provided. The method includes making available source information (311) for a message (310) being published. The source information includes: a topic of the published message (310); any source topics the topic of the published message (310) is derived from; and a message of the published message (310). The method further includes subscribing (314) to source information for a message topic. The subscribing (314) may include recursively subscribing to source information for a source topic in order to obtain live source information for a message (310).

This invention relates to the field providing source information of data being published. In particular, it relates to the source of data published in a publish/subscribe messaging system.

Publish/subscribe is an asynchronous messaging paradigm. In a publish/subscribe system, publishers post messages to an intermediary broker and subscribers register subscriptions with that broker. In a topic-based system, messages are published to “topics” or named logical channels which are hosted by the broker. Subscribers in a topic-based system will receive all messages published to the topics to which they subscribe and all subscribers to a topic will receive the same messages.

It is important to know where data or information has come from in order to be able to know how much reliance can be placed on the data or information. It is also often important to be able to determine where data is derived from if there is more than one source of data.

In publish/subscribe systems multiple publishers can publish data or information to multiple subscribers. A problem arises in that the subscribers do not know how much reliance to place on the published content. Subscribers need to ask publishers “Where is your data from?”.

Prior art focuses on the history of stored data and the derivation of information. It is an aim of the present invention to provide a method and system for providing source information for live data with live sources.

According to a first aspect of the present invention there is provided a method for providing source information of data being published, comprising: making available source information for a message, the source information including: a message topic; and any source topics the message topic is derived from; subscribing to source information for a message topic.

In one embodiment, making available the source information publishes the source information in the message. In another embodiment, making available the source information publishes the source information in a separate topic.

Subscribing to source information for a message topic may result in a hierarchy of source topics on which the message topic is dependent. Alternatively, a subscribing to source information for a message topic may include recursively subscribing to source information for source topics of interest.

The message may have a message indicating a live status and subscribing to source information for source topics may provide the messages for source topics including live status information on the source topics, providing a live network which can be monitored. The method may include checking status information of source topics, and if a source topic status is not good, subscribing to the source information for that source topic. The method may include determining if the status of a source topic is not good and, if the source topic is an endpoint, issuing a problem alert.

Multiple publishers may make available source information for a topic and new source information for a topic overwrites existing source information for the topic, or the source information may be combined using policies.

According to a second aspect of the present invention there is provided a system for providing source information of data being published, comprising: at least one publisher application including means for making available source information for a message, the source information including: a message topic; and any source topics the message topic is derived from; a message broker including means for storing and processing source information provided by the at least one publisher application; and a subscriber application subscribing to source information for a topic.

The message may indicate live status information. The messages for source topics may include live status information on the source topics, providing a live network which can be monitored. The system may include a monitoring means for the live network in the form of a subscriber application monitoring messages of topic hierarchies.

According to a third aspect of the present invention there is provided a computer program product stored on a computer readable storage medium, comprising computer readable program code means for performing the steps of: making available source information for a message, the source information including: a message topic; and any source topics the message topic is derived from; and subscribing to source information for a message topic.

Embodiments of the present invention will now be described, by way of examples only, with reference to the accompanying drawings in which:

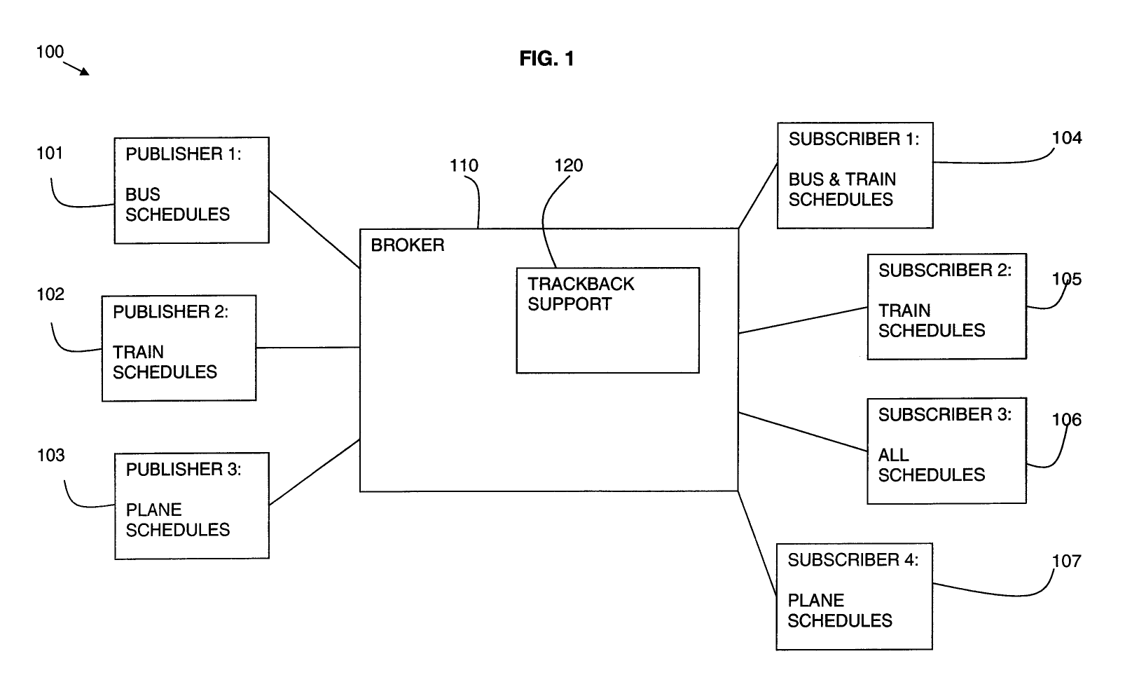

FIG. 1 is a block diagram of a system in accordance with the present invention;

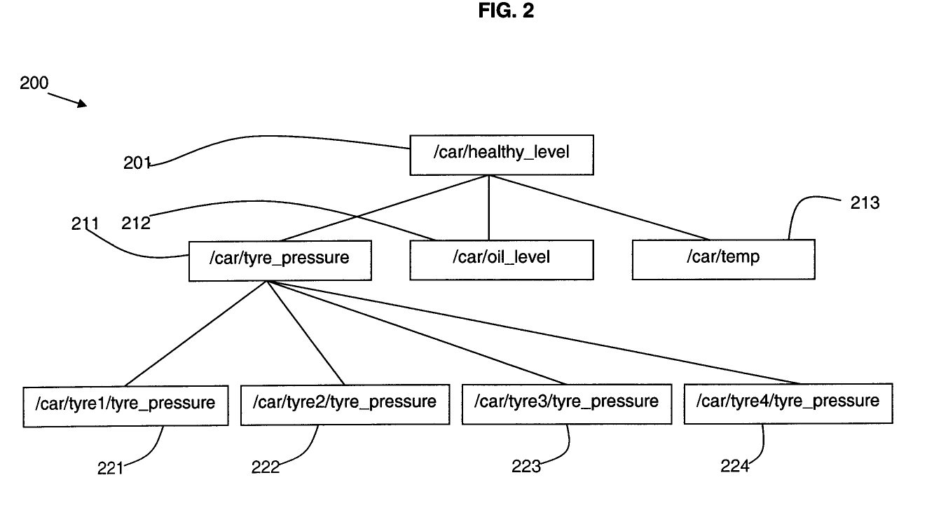

FIG. 2 is a diagram of a topic hierarchy in accordance with the present invention;

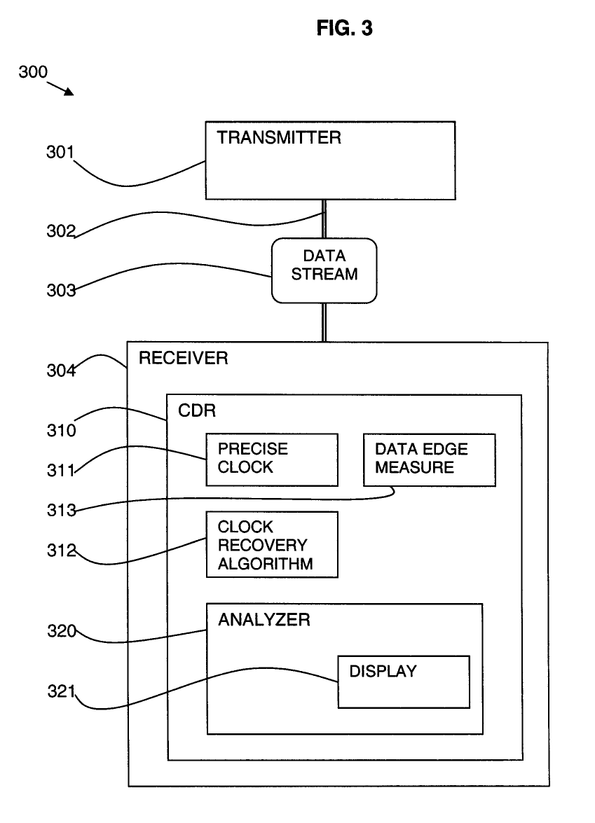

FIG. 3 is a schematic diagram of a publish/subscribe system in accordance with the present invention showing a flow of messages;

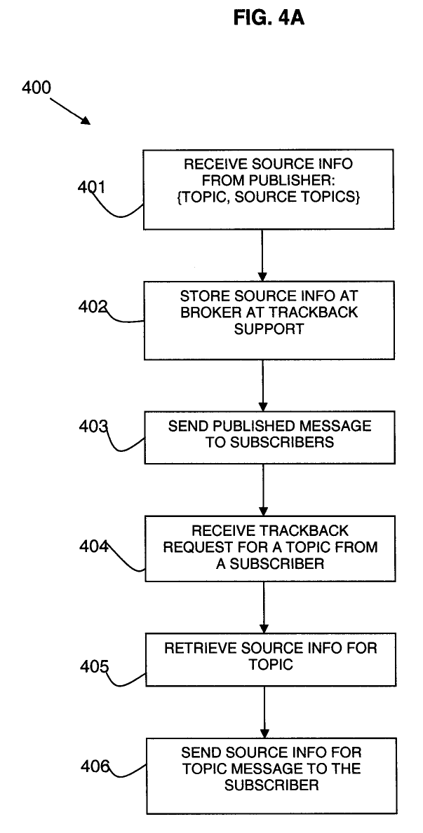

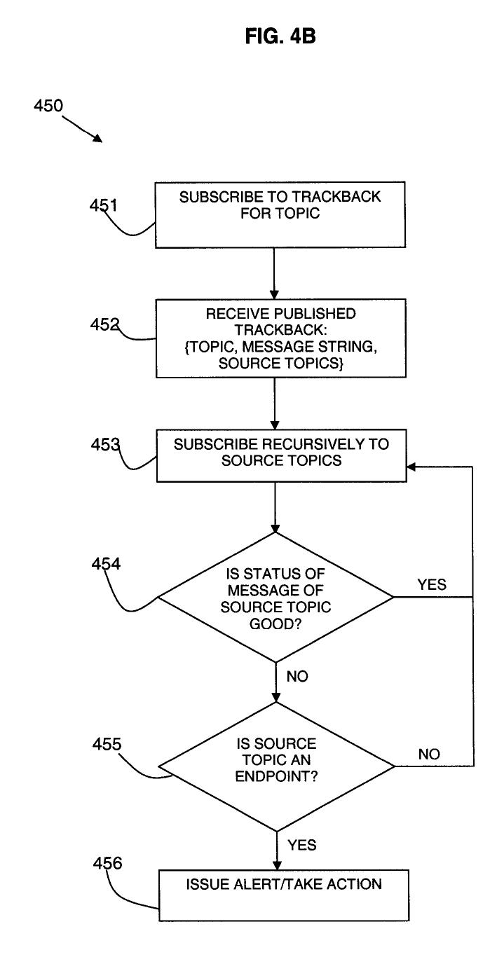

FIG. 4A is a flow diagram in accordance with an aspect of the present invention; and

FIG. 4B is a flow diagram in accordance with an aspect of the present invention.

Publish/subscribe messaging is intended for situations where a single message needs to be distributed to multiple users. An advantage over other delivery methods is that publish/subscribe systems keep the publisher separated from the subscriber. This means that the publisher in a publish/subscribe system does not need to have any knowledge of either the subscriber's existence or the applications that may use the published information. Likewise, the subscriber does not know anything about the publisher or the source of the published data or information.

A publish/subscribe system 100 is shown in FIG. 1 and has one or more publisher applications 101-103 who publish messages to a broker 110, and a group of subscriber applications 104-107 who subscribe to some or all of those published messages that are held on the broker 110. The system matches the publications to the subscriber applications 104-107 and ensures that all the messages are made available and delivered to all the subscriber applications 104-107 in a timely manner.

Multiple brokers can be connected together, enabling brokers to exchange messages. This allows subscriber applications subscribing to one of the brokers to pick up messages that have been published to another broker, further freeing the subscriber applications from the constraints of using the same broker as the publisher application.

As an example, the publisher applications 101-103 may publish messages concerned with transport schedule information onto the broker 110. A first publisher application 101 may publish bus schedule information, a second publisher application 102 may publish train schedule information, and a third publisher application 103 may publish plane schedule information. Subscriber applications 104-107 can choose to subscribe or unsubscribe to the information available on the broker as necessary. In this example, a first subscriber application 104 may subscribe to bus and train schedule information, a second subscriber application 105 may subscribe to only train schedule information, a third subscriber application 106 may subscribe to all schedule information, and a fourth subscriber application 107 may subscribe to only plane schedule information.

The subscriber applications are able to choose between receiving the messages published, or just some of the messages based upon various criteria that are important to them.

In the publish/subscribe system 100, subscriber applications 104-107 typically receive only a sub-set of the total messages published. The process of selecting messages for reception and processing is called filtering.

In a topic-based system, messages are published to “topics” or named logical channels. Subscribers in a topic-based system will receive all messages published to the topics to which they subscribe, and all subscribers to a topic will receive the same messages. The publisher application is responsible for defining the classes of messages to which subscribers can subscribe.

A subscriber subscribes to a topic and this can be further restricted by subscribing to a topic based on message content using message selector.

Publish/subscribe applications are widely used as a means of easily disseminating information to multiple users who may be interested in some or all of the information available.

The described publish/subscribe system 100 includes a trackback support 120 at the broker 110 which provides a method and system for providing and obtaining information as to the source of the published information.

The publisher applications 101-103 make available source information referred to as trackback information which is stored on the broker 110. This may be for a message being published or for a topic of a message being published.

The trackback information includes the topic of the message and the topics that the message relies on—the source topics. If the trackback information is published for a message, the trackback information may also include the message itself.

In one embodiment, the trackback information is included in a message and a method is used by all publisher applications:
publish(String topic, String message, String[ ] trackbackTopics)

However, it is not necessary to include trackback information in every message. The trackback information can be provided separately in a different topic to reduce unnecessary overheads. The broker may then process the trackback information for relaying to subscribers.

A subscriber application 104-107 wishing to know the origin of the information contained in a message, can request trackback information for a topic from the broker 110. The following method is made available to subscriber applications:
trackback(String topic).

In an alternative embodiment, the subscriber may request trackback on a particular message by using:
trackback(String topic, int n), where n is the n-th message that the subscriber is interested in.

The broker 110 on receiving a trackback request from a subscriber application retraces the trackback information it has stored from the publisher applications 101-103 and supplies the trackback information to the subscriber application 104-107.

A subscriber application can request further trackback information for source topics of interest defined in trackback information for a topic. The source topics can be traced back through a topic hierarchy as far back as the subscriber application requires. For example, trackback (“car/health_level”) can be sent by a subscriber which goes to the broker as part of the protocol, and the broker replies with list of topics this topic is derived from, and the subscriber receives this.

The broker 110 may include means for tracing back through stored source topics of a topic hierarchy for a trackback request for a topic. The broker 110 may publish the source hierarchy to the subscriber application.

There may be multiple publisher applications who publish messages to a topic. There are different approaches which can be used to address this. For example, any new publish may overwrite any older publish. More advanced examples would be where multiple publishes are combined/merged using policies.

The trackback information can be included in a message's header, or the actual message, or a mixture of both (e.g. XML). It's up to the messaging protocol on how the information is encoded, transported, and decoded.

An alternative is that the information could be stored separately and the user can receive the trackback information on a topic by other means. This is to say, the trackback information of a topic can be received separately from the topic's messages.

### EXAMPLE 1

An example is used to illustrate the described method and system. A car has a publisher which publishes the information:
/car/health_level publishing “Good”

More information may be requested. The /car/health_level topic is based on the following topics:

/car/tyre_pressure
/car/oil_level
/car/temp

The /car/trye_pressure in turns depends on:

/car/tyre1/tyre_pressure
/car/tyre2/tyre_pressure
/car/tyre3/tyre_pressure
/car/tyre4/tyre_pressure

This topic hierarchy 200 is shown in FIG. 2. The /car/health_level 201 is at the top of the hierarchy 200 and has source topics /car/tyre_pressure 211, /car/oil_level 212, and /car/temp 213. The source topic /car/tyre_pressure 211 itself has source topics /car/tyre1/tyre_pressure 221, /car/tyre2/tyre_pressure 222, /car/tyre3/tyre_pressure 223, and /car/tyre4/tyre_pressure 224.

The described trackback method enables subscribers to ask the broker the question: “Where does /car/health_level get its information from?”

The publisher of a topic (“/car/health_level”) itself knows that it produces information for this topic from other topics (“/car/tyre_pressure”, “/car/oil_level”, and “/car/temp”) and so this publisher specifies these topics to the broker for trackbacking purposes. The broker software is implemented with trackback support such that the following method is used by all publishers:
publish(String topic, String message, String[ ] trackbackTopics)

The field trackbackTopics lists the source topics the topic is derived from, or can be empty. The car example above, for example, will publish the following:

publish(“/car/health_level”, “Good”, {“/car/trye_pressure”,
“/car/oil_level”, “/car/temp”})

This tells the broker that the topic “/car/health_level” publishing “Good” was based on the topics “/car/tyre_pressure”, “/car/oil_level”, and “/car/temp”.

The following method is also made available to subscribers:
trackback(String topic)

A subscriber of the “/car/health_level” topic may want to know more and can execute the following:
trackback(“/car/health_level”)

In return the subscriber gets the topics “/car/tyre_pressure”, “/car/oil_level”, and “/car/temp”.

The same method can be executed on the “/car/tyre_pressure” topic to get the individual wheel topics.

The subscriber gets the literal information, and it is up to the subscriber whether to subscribe to the returned topics, or just take a look at them and, for example, produce output to the user “This topic was produced using information from the following topics: /car/tyre_pressure, /car/oil_level, /car/temp”.

### EXAMPLE 2

The above example is of a very small network. Another example illustrates the usefulness of this disclosure for a larger example. The example is of an electricity company controlling the distribution of electricity across a country. The electricity network consists of millions of end user points. The network is not static; it is ever changing. For example:
all the time new end user points are connected (new houses, new lampposts, new wind turbines, etc.);
existing ones are being disconnected (thunderstorms, a big failures, etc.);
usage spikes are occurring (a town having a power cut, then back on again, etc.).

There are times where the changes seriously affect the stability of the electricity distribution. It is important to pinpoint where the problem is as soon as possible. This can be addressed by having a monitoring centre which must have an up-to-date, “live” network, taking into account any changes that happen all the time. If a new connection is made, the monitoring centre needs to know in case that connection destabilise the electricity network. A problem of this centralised monitoring centre is that it is costly to maintain a live network.

The described method and system provides a means to achieve this by making the centralisation of the network an intrinsic essence of the solution through the use of the trackback technique. This technique allows the problem to be pinpointed by means of a recursive method; i.e., recursively asking “Where is your data from?” until the offending point is reached.

To illustrate the centralisation of multiple autonomous publish/subscribe sub-networks, the electricity grid example as explained above is used. The grid is not static, it is ever changing. The following method can be executed to pinpoint the offending endpoint “live” without relying on stored data:

pinpoint_offender (top_level_topic) {

topics = trackback(top_level_topic);
for each topic in topics {

status = check_topic(topic);
if (status == bad) {

if (topic == endpoint) {

/* do something here to rectify the problem */

} else if (topic == subnetwork) {

/* this is the recursive call */
pinpoint-offender(topic);

}

}

}

}

The method can be turned into a “loop”, continuously executing the same algorithm, and it will always have a “live” version of the grid. Even if new endpoints are added, or removed, halfway through the execution of the algorithm, the information will still be “live” and correct.

### EXAMPLE 3

In a publish/subscribe environment, messages can be influenced by other messages. This can be illustrated with an example of a oil company controlling a long oil pipe.

One of the most important topics in this example is the overall “pressure” topic:
/oilpipe/pressure publishing “90%”

This is inferred from a number of topics, giving the status of individual sections of the long oil pipe:

/oilpipe/section_1/pressure publishing “100%”
/oilpipe/section_2/pressure publishing “70%”
/oilpipe/section_3/pressure publishing “100%”

This gives an overall mean of 90% and hence the overall pressure is 90%. The 70% pressure in turn has a number of subsections:

/oilpipe/section_2/subsection_1/pressure publishing “90%”
/oilpipe/section_2/subsection_2/pressure publishing “20%”
/oilpipe/section_2/subsection_2/pressure publishing “100%”

The oil company is controlling thousands of oil pipes, and hence millions of sections, and billions of subsections. The individual sections are run and maintained by different teams, of different languages, with different equipments. The oil company has a monitoring centre which ensures that the oil pipes are all running well.

The monitoring centre can subscribe to /oil/pressure for the overall pressure of all oil pipes. When the pressure goes down to 90%, the monitoring centre needs to know where the problem lies.

This can be achieved by the monitoring centre requesting trackback information on:
/oil/pressure which published “90%”,

followed by trackback information on:
/oilpipe/section 2/pressure which published “70%”,

followed by trackback information on:
/oilpipe/section_{—}2/subsection 2/pressure which published “20%”.

This method tracks the source of the problem back to the relevant live subsection and this information can be acted upon to rectify the problem.

The published messages may include live status information in the form of a message string or other forms of message, for example, a live image of a pipe to monitor the status.

Referring to FIG. 3, a schematic flow diagram 300 shows the described method and system. A publisher 301 publishes a message 310 to a broker 302. In this example, the message 310 relates to topic “A”, has a message string “90%”. The message also has source topics specified as B and C. The published source information is stored 320 at the trackback support 303 of the broker 302.

A subscriber 304 subscribes 311 to the topic A and receives a message 312 of “90%”. The subscriber 304 wishes to determine the source of this figure and subscribes to a trackback 313 for topic A. A publication 314 is returned by the trackback support 303 of the broker 302 specifying that the topic A with message “90%” had source topics B and C.

The subscriber 304 can then subscribe to a trackback 315 for each of topics B and C. The trackback support 303 of the broker 302 has previously stored the trackback information for the source topics when they were last published. So, the trackback support 303 retrieves the trackback information for the source topics B and C and publishes 316, 317 this to the subscriber 304.

In this example, the trackback information 316 for topic B shows a message string of “20%” and is an endpoint as there are no source topics for topic B. This indicates that the problem lies with topic B.

The trackback information 317 for topic C shows a message string of “90%” with source topics D and E. However, further investigation into the source topics of topic C is not required as this has a good message level and the problem has been located at topic B.

In the example shown in FIG. 3, the subscriber iterates its trackback request to obtain each level of source information. The broker may publish the whole hierarchy to the subscriber on request.

The trackback information is always “live” and up-to-date. It will never be outdated. This is because whenever any of the trackbacked topics is outdated, the topic depending on this gets updated thanks to the essence of publish/subscribe.

This is because the uppermost topic is derived from the topics below it. For example, “car/health level” is derived from “car/oil_level” and “car/temp”. A message in the uppermost level (car/health level publishing “good”) is deduced from information from the next level (car/oil_level publishing “100%” and car/temp publishing “25 degrees”). A trackbacking process goes down the hierarchy, not up. Therefore, a trackback process goes to the source of the information (any of the bottom level topics), rather than up to the deduced information away from sources during which the sources could become outdated.

The algorithm above is simplified to illustrate the method. However, it needs to be extended to cover events that may not be trackback-related but are important for a “live” network.

For example, a topic may be used which has just been revised (a sub-section of pipe may have been fixed to 100% from 60%), or a topic which has been relocated elsewhere (an electricity sub-network may have a new underground link), and other similar scenarios. Situations such as these can be addressed by throwing a trackback exception or a thread interrupting exception. For example, throwing a trackback exception may tell the algorithm: “This is ok, go back to the previous topic and check again”. Throwing a thread interrupting exception (for example for the new link) may tell the algorithm: “The linkage has been split, check both ends”.

In some cases, care is needed for any potential infinite loops. This can be addressed by applying an anti-infinite loop technique to the algorithm.

Referring to FIGS. 4A and 4B, flow diagrams are provided showing the method steps 400 at a broker (FIG. 4A) and method steps 450 at a subscriber (FIG. 4B).

FIG. 4A shows the method steps 400 at a broker. The source topics for a given topic or message are provided 401 by a publisher. The broker stores 402 the source information at a trackback support. The broker then sends 403 the published message to subscribers of the topic. A subscriber may request trackback information for the received message and the broker will receive 404 a trackback request for the topic of the message. The broker retrieves 405 the source information from the trackback support and publishes 406 this to the subscriber.

FIG. 4B shows the method steps 450 at a subscriber. The subscriber subscribes 451 to a trackback for a topic. The subscriber receives 452 the published trackback information including the source topics. The subscriber may then subscribe recursively 453 to source topics.

At each source topic, it is determined 454 if the status of the message of the source topic is good. If so, the method loops to the next source topic either on the same level or on a next level in a topic hierarchy. If the status is not good, it is determined 455 if the source topic is an endpoint. If it is not an endpoint, the method loops to the source topics of the poor source topic. If it is an endpoint, action is taken 456 or an alert is issued.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

1. A method for providing source information of data being published, comprising:
making available source information for a message, the source information including:
a message topic; and
any source topics the message topic is derived from;
subscribing to source information for a message topic.

2. The method as claimed in claim 1, wherein making available the source information publishes the source information in the message.

3. The method as claimed in claim 1, wherein making available the source information publishes the source information in a separate topic.

4. The method as claimed in claim 1, wherein the message indicates a live status.

5. The method as claimed in claim 1, wherein subscribing to source information subscribes to source information for a specified message within a topic.

6. The method as claimed in claim 1, wherein subscribing to source information for a message topic results in a hierarchy of source topics on which the message topic is dependent.

7. The method as claimed in claim 1, wherein a subscribing to source information for a message topic includes recursively subscribing to source information for source topics.

8. The method as claimed in claim 6, wherein subscribing to source information for source topics provides the messages for source topics including live status information on the source topics, providing a live network which can be monitored.

9. The method as claimed in claim 8, including checking status information of source topics, and wherein a source topic status is not good, subscribing to the source information for that source topic.

10. The method as claimed in claim 9, including determining if the status of a source topic is not good and, if the source topic is an endpoint, issuing a problem alert.

11. The method as claimed in claim 1, wherein multiple publishers make available source information for a topic and new source information for a topic overwrites existing source information for the topic.

12. The method as claimed in claim 1, wherein multiple publishers make available source information for a topic and the source information is combined using policies.

13. The method as claimed in claim 1, including storing and processing source information at a message broker.

14. A system for providing source information of data being published, comprising:
at least one publisher application including means for making available source information for a message, the source information including:
a message topic; and
any source topics the message topic is derived from;
a message broker including means for storing and processing source information provided by the at least one publisher application; and
a subscriber application subscribing to source information for a topic.

15. The system as claimed in claim 14, wherein the message indicates live status information.

16. The system as claimed in claim 14, wherein the message broker provides a hierarchy of source topics to a subscriber application.

17. The system as claimed in claim 14, including:
means for a subscriber application to subscribe recursively to source information for a source topic.

18. The system as claimed in claim 14, wherein the messages for source topics include live status information on the source topics, providing a live network which can be monitored.

19. The system as claimed in claim 18, including a monitoring means for the live network in the form of a subscriber application monitoring messages of topic hierarchies.

20. The system as claimed in claim 19, wherein the monitoring means includes means for checking status information of topics, and wherein if a topic status is not good, subscribing to the source information for that topic.

21. The system as claimed in claim 20, wherein the monitoring means includes means for issuing a problem alert if a topic is an endpoint and the status is not good.

22. A computer program product stored on a computer readable storage medium, comprising computer readable program code means for performing the steps of:
making available source information for a message, the source information including:
a message topic; and
any source topics the message topic is derived from; and
subscribing to source information for a message topic.
